(19) United States
(12) Patent Application Publication
(10) Pub. No.: US 2016/0140205 A1
(43) Pub. Date: May 19, 2016

(54) QUERIES INVOLVING MULTIPLE DATABASES AND EXECUTION ENGINES

(71) Applicant: HEWLETT-PACKARD DEVELOPMENT COMPANY, L.P., Houston, TX (US)

(72) Inventors: Meichun Hsu, Los Altos Hills, CA (US); Qiming Chen, Cupertino, CA (US)

(21) Appl. No.: 14/787,302

(22) PCT Filed: Aug. 29, 2013
(86) PCT No.: PCT/US13/57252

§ 371 Date: Oct. 27, 2015

(51) Int. Cl. G06F 17/30

(52) U.S. Cl. CPC G06F 17/30592; G06F 17/30563; G06F 17/30516

(57) ABSTRACT

Described herein are techniques for handling a query that uses first data from a first database and second data from a second database. The first database is accessible via a first execution engine, and the second database is accessible via a second execution engine. A sub-query of the query can be sent to the second execution engine for execution on the second database. Streaming results of the sub-query can be received by the first execution engine.

### BACKGROUND

Database Management Systems (DBMS) can be used to store, manage, and query data, Online Transaction Processing (OLTP) systems and Online Analytical Processing (OLAP) systems are examples of DBMS's used by enterprises to manage and extract value from the loads of data generated during the course of operations. Each system can include a database and an execution engine for accessing the database. However, the systems differ in terms of their suitability for certain operations.

In general, an OLTP system is used to maintain detailed and current data for an enterprise. OLTP systems usually deal with a large number of concurrent but short queries with read/write operations. The main emphases for OLTP systems are fast query processing and maintaining data integrity in multi-access environments. Effectiveness of the system is often measured by number of transactions per second. A telecommunication enterprise or a bank might use an OLTP system for maintaining customer accounts and processing the thousands of transactions (e.g., calls, charges) each day.

On the other hand, an OLAP system is generally used to store historical and aggregated data for an enterprise, OLAP systems are generally suitable for large, long-running analytical queries with read-only operations. The queries running on an OLAP system can be very complex. Effectiveness of the system is often measured by response time (e.g., how long it takes for a query to execute). A telecommunication enterprise or bank might use an OLAP system for analyzing data generated by the OLTP system. Examples of such analytics are business intelligence, customer behavior profiling, and fraud detection.

### BRIEF DESCRIPTION OF DRAWINGS

The following detailed description refers to the drawings, wherein:

FIG. 1 illustrates a method of handling a query involving multiple data sources, according to an example.

FIG. 2 illustrates a method of handling a query involving multiple data sources, according to an example.

FIG. 3 illustrates a computing system for handling a query involving multiple data sources, according to an example.

FIG. 4 illustrates a computer-readable medium for handling a query involving multiple data sources, according to an example.

### DETAILED DESCRIPTION

As described herein, a data processing platform is presented which enables the integration of an OLTP system and an OLAP system. The difference between the OLTP and OLAP systems is often architectural, as OLTP systems generally emphasize the data consistency in updates while OLAP systems are read-optimized. As an example, the Vertica DBMS as an OLAP system is based on the column oriented data model for read optimization, while the PostgreSQL DBMS as an OLTP system is based on the row oriented data model for write optimization. The impact of architecture on workload characteristics thus leads to different design of OLTP and OLAP systems. As a result of the different architectures, configuring an OLTP system to handle OLAP workload, or vice versa, often results in unsatisfactory performance. Thus, configuring a single execution engine to handle multiple types of workloads and access multiple types of databases may be unsatisfactory.

If integration were attempted at the database level instead, problems could arise due to differences in the way OLTP systems and OLAP systems manage their data. For example, OLTP databases typically keep the most recent data in a buffer pool for high throughput updates, such that the data on disk could be “dirty” (i.e., not up-to-date) if the buffer pool contents have not been synchronized with the disk (such as by using the fsync operation). As a result, data integrity could be compromised. Finally, adding an engine via middleware on top of the OLTP and OLAP systems may slow processing speed and could raise architectural problems of its own, as optimization decisions would need to be decided for the middleware engine. Nonetheless, many enterprises deal with OLTP in their operations as well as OLAP in their data-warehousing applications, and thus integrating the two systems would be beneficial.

To avoid some of the drawbacks of integration at the engine level, database level, and middleware level, techniques disclosed herein achieve integration at the query level. For example, the techniques disclosed herein can allow an OLTP engine to treat the OLAP query results as a data source, allow the OLAP engine to treat the OLTP query results as a data source, and allow joining the query results generated by both engines. Accordingly, under this approach data stored in both OLTP and OLAP databases can be queried by a query either issued to the OLTP engine or to the OLAP engine. For a query issued to the OLTP engine, a query result generated by the OLAP engine can be taken as the OLTP engine's data source, and vice versa.

Additionally, to avoid the overhead of copying or materializing the data from one database to another, which can be especially useful when dealing with large amounts of data, function-scan can be used rather than table scan for a query to retrieve the data from other databases directly in the streaming context. This mechanism can ease the memory requirement for generating temporary tables, reduce the cost of disk access, and naturally leverage query engine stream processing capability.

In light of the above, according to an example, a technique implementing the principles described herein can include issuing a query that uses first data stored in a first database and second data stored in a second database, a first execution engine being associated with the first database and a second execution engine being associated with the second database. The first database and execution engine can be part of an OLTP system and the second database and execution engine can be part of an OLAP system. The technique further includes sending a sub-query of the query to the second execution engine for execution over the second database to retrieve the second data. The technique further includes receiving the second data at the first execution engine in a streaming tuple-by-tuple format from the second execution engine, and executing a remainder of the query. Receiving the second data at the first execution engine in a streaming tuple-by-tuple format from the second execution engine can be achieved by receiving the second data at the first execution engine directly from the second execution engine rather than the second data being materialized in a table before being received by the first execution engine. This technique can avoid many of the disadvantages associated with other techniques for integrating an OLTP system and an OLAP system. Additional examples, advantages, features, modifications and the like are described below with reference to the drawings.

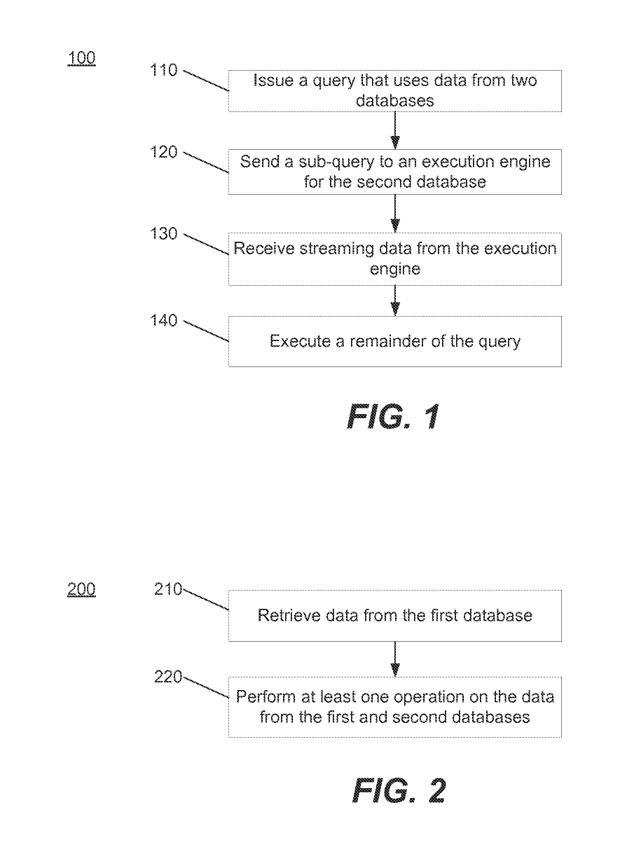

FIG. 1 illustrates a method of handling a query involving multiple data sources, according to an example. Method 100 may be performed by a computing device, system, or computer, such as processing system 300 or computing system 400. Computer-readable instructions for implementing method 100 may be stored on a computer readable storage medium. These instructions as stored on the medium are referred to herein as “modules” and may be executed by a computer.

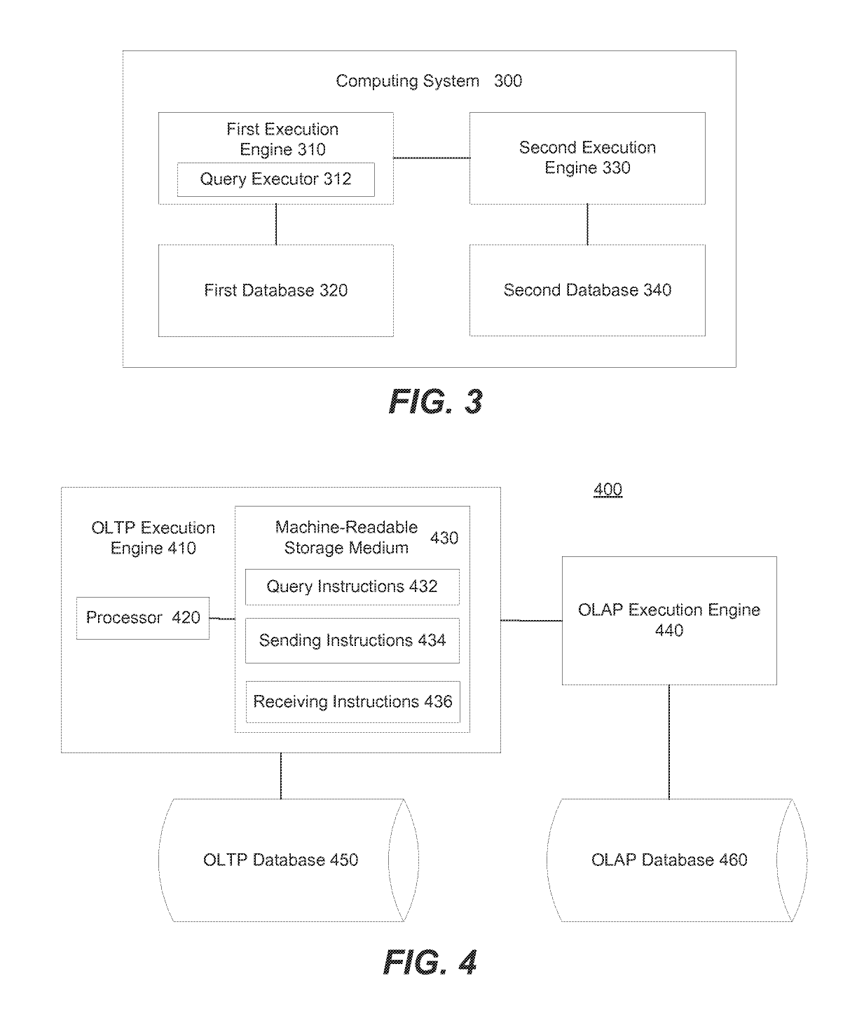

Method 100 will be described here relative to example processing system 300 of FIG. 3. System 300 may include and/or be implemented by one or more computers. For example, the computers may be server computers, workstation computers, desktop computers, laptops, mobile devices, or the like, and may be part of a distributed system. The computers may include one or more controllers and one or more machine-readable storage media.

A controller may include a processor and a memory for implementing machine readable instructions. The processor may include at least one central processing unit (CPU), at least one semiconductor-based microprocessor, at least one digital signal processor (DSP) such as a digital image processing unit, other hardware devices or processing elements suitable to retrieve and execute instructions stored in memory, or combinations thereof. The processor can include single or multiple cores on a chip, multiple cores across multiple chips, multiple cores across multiple devices, or combinations thereof. The processor may fetch, decode, and execute instructions from memory to perform various functions. As an alternative or in addition to retrieving and executing instructions, the processor may include at least one integrated circuit (IC), other control logic, other electronic circuits, or combinations thereof that include a number of electronic components for performing various tasks or functions.

The controller may include memory, such as a machine-readable storage medium. The machine-readable storage medium may be any electronic, magnetic, optical, or other physical storage device that contains or stores executable instructions. Thus, the machine-readable storage medium may comprise, for example, various Random Access Memory (RAM), Read Only Memory (ROM), flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable storage medium can be computer-readable and non-transitory. Additionally, system 200 may include one or more machine-readable storage media separate from the one or more controllers.

Method 100 may begin at 110, where a query may be issued. The query may require data stored in multiple databases. For example, to fully execute, the query may require first data stored in a first database 320 and second data stored in a second database 340. The first database 320 may be accessible via a first execution engine 310 and the second database 340 may be accessible via a second execution engine 330. The first execution engine 310 can include a query executor 312 to execute the query according to the disclosed techniques.

In some examples, the second database 340 may be inaccessible via the first execution engine 310, and the first database 320 may be inaccessible via the second execution engine 330. In other examples, the databases may be accessible via either execution engine, but there may be drawbacks to such accessibility, such as processing or memory overhead, compromised data integrity, or the like.

The first and second databases 320, 340 and respective engines 310, 330 may be based on different architectures and may store different data. For example, the first execution engine 310 and database 320 may be part of an OLTP system while the second execution engine 330 and database 340 may be part of an OLAP system, or vice versa. The systems together may constitute part of a larger DBMS for an enterprise, such as a telecommunications enterprise. For instance, the OLTP database (e.g., first database 320) may store current data generated as part of the operations of the telecommunications enterprise, while the OLAP database (e.g., second database 340) may store historical data for analytics. While some of the data may overlap between the two databases, the OLTP database will generally have more current data than the OLAP database (such data thus being unavailable in the OLAP database), while the OLAP database may have more data than the OLTP database (such data thus being unavailable in the OLTP database).

Due to the lack of availability of certain data on one database or the other, a query sometimes may require data stored on both databases. For example, a query may require first data stored on the first database and second data stored on the second database. For instance, the telecommunications enterprise may desire to determine call volume for one or more customers over a one week period, up to the present time. The previous six days' call information may be stored as historical data in the OLAP database (e.g., the second database 340), while today's call information may be still stored in the OLTP database (e.g., the first database 320), having not yet been transferred to the OLAP database (which transfer might occur at midnight each day, for example). Thus, a query requesting such information would require data from both the OLAP database and the OLTP database.

To address this problem, the query (referred to herein as a “host query”) may include a sub-query directed to a specific database. In particular, for example, the host query may be issued by the first execution engine 310 (e.g., via query executor 312) but may include a sub-query directed to the second execution engine 330. The sub-query may be configured to request the second data required from the second database 340, so that the first execution engine 310 can fully execute the host query using the second data as well as first data retrieved from the first database 320. The sub-query may be connected to the host query via a query connector function, as will be described in detail later.

At 120, the sub-query may be sent to the second execution engine 330 for execution over the second database 340 to retrieve the second data, The sub-query may be sent to the second execution engine 330 by query executor 312. The second execution engine 330 may execute the sub-query to retrieve the second data from second database 340.

At 130, the second data may be received by the query executor 312 at the first execution engine 310. The second data may be received directly from the second execution engine 330 in a streaming format, rather than being temporally stored in a table before being received at the first execution engine 310. This streaming second data may be fed directly into the host query. Thus, the first execution engine 310 may treat the query results of the second execution engine 330 as a direct data source for the host query.

At 140, a remainder of the host query may be executed by the query executor 312 at the first execution engine 310. FIG. 2 depicts an example method for execution of the remainder of the host query. At 210, first data may be retrieved from the first database 320. For example, first execution engine 310 may access first database 320 to retrieve the data required from the first database 320, as specified by the host query. This first data retrieved from the first database 320 may serve as another direct data source for the host query. At 220, at least one operation specified by the host query may be performed using the first data and the second data. For example, the first data and second data may be joined, unioned, sorted, filtered, etc. The results of the host query may then be returned, as appropriate.

As mentioned above, the sub-query may be connected to the host query via a query connector function (QCF). The QCF is configured to cause/allow the second data to be delivered to the host query at the first execution engine 310 from the second execution engine 330 without any intermediate materialization in a streaming, tuple-by-tuple format. Thus, the overhead of storing data intermediately on disk (e.g., in the form of a temporary table) can be avoided.

The QCF is a type of table function that returns a sequence of tuples to feed a query (here, the host query). The query connector function takes a query (here, the sub-query) as its argument, and can be implemented as follows. From the execution engine issuing the query (here, the first execution engine 310), the QCF may issue an Open Database Connectivity (ODBC) or Java Database Connectivity (JDBC) connection to the target database (here, the second database 340 via the second execution engine 330) with certain connection information (e.g., URL, driver, authentication, etc.). The QCF then causes the second execution engine 330 to execute the query that was passed in as an argument to the QCF (here, the sub-query). The QCF then generates output tuples one by one to feed the host query, based on the schema of the resulting relation (as provided in the ODBC/JDBC ResultSetMetadata). These output tuples constitute the second data and may be fed into the host query by the first execution engine.

In an example implementation, PostgreSQL may be the OLTP execution engine and Vertica may be the OLAP execution engine. In the PostgreSQL engine, the QCF may be implemented based on PostgreSQL's Set Return Function, which is a kind of table function that can generate tuples from the passed in query and output the tuples one by one. Such a function is called multiple times during the execution of a query, each call returning one tuple. By extending the PostgreSQL's function-scan mechanism to un-block the QCF output, the query can thus be fed continuously, tuple-by-tuple. The function scan is supported at two levels: the function scan level and the query executor level. The data structure containing function call information bridges these two levels and may be initiated by the query executor and passed in/out of the QCF for exchanging function invocation related information. In the Vertica engine, the User Defined Transform Function (UDTF) can be used to read the rows returned from the passed-in query and return zero or more rows of the query results. A UDTF loops over the input tuples, but in this usage the input to the function would be considered to be a single tuple.

A use case example involving a telecommunication enterprise's DBMS will now be described. The DBMS has three databases: an Operational Database (ODB), an Operational Data Store (ODS), and an Enterprise Data Warehouse (EDW). An integrated charging system handles the customer verification, charging, and account update functions on telephone, messaging, data communication, etc. The integrated charging system may be supported by the ODB system, which has workload characteristics of an OLTP system. A billing system records the details of customer activities to be listed in the bills and is supported by the ODS system, which has workload characteristics in between OLTP and OLAP in the sense that it is write centered but dominated by append-only operations. The EDW system keeps track of the historical data for business intelligence, customer behavior profiling, fraud detection, etc. The EDW system runs large analytical queries with intra-query parallelism supported by a parallel database and thus has workload characteristics of an OLAP system.

The ODB system may maintain a table (“account”) for keeping customer accounts information, with attributes such as customer_id, name, service_plan, balance, etc. The ODS system may maintain a call detail record (CDR) table for recording the CDR information, with attributes such as customer_id, call_time, call_duration, call_destination, etc. The EDW database may maintain the historical raw data imported from the ODS database (e.g., with a per-day frequency) as well as derived summary information, with a table called “daily_agg” and attributes such as customer_id, date, volume, duration, etc.

Both the ODB and ODS are updated by each CDR received by the integrated charging system. Under an “intelligent” charging policy implemented by the telecommunication enterprise, the cost of each call is calculated by taking into account the calling volume of the past week under the principle of “the more you call, the more you save”. Thus, a query to obtain calling volume for the past week will require information from both the ODB system and the EDW system. A query applied to the ODB system, using both the ODB system and the EDW system as data sources, may be implemented using a query connector function in Structured Query Language (SQL) as follows:

```
SELECT customer_id, name, service_plan, date, volume
    FROM account a,
      qcf(‘SELECT customer_id, date, volume FROM daily_agg
          WHERE volume = (SELECT MAX(volume) FROM
daily_agg)’) b
      WHERE a.customer_id = b.customer_id
```

The italicized text indicates the query connector function “qcf” and its passed-in argument, which is a sub-query directed to the EDW system. The results of the sub-query will be returned to the ODB execution engine and fed directly into the query for full execution. In particular, the “account” table from the ODB is joined with the query results from the sub-query to provide the queried calling volume.

As another example, a query for summarizing the calling status from the last week (7 days) until “now” (a partial day) may require unioning of information retrieved from the EDW and the ODS. The summarization of call volume for the current day may be retrieved from the ODS system by the following query:

SELECT customer_id, COUNT(*) FROM cdr GROUP BY
customer_id

Accordingly, a query issued to the EDW may union the result of Q3 retrieved from the ODS, and sum-up it with the last week's aggregation retrieved from the EDW, as follows. Again, the query connector function along with the passed-in argument (i.e., the above query to the ODS system) is highlighted in italicized text.

```
SELECT customer_id, SUM(vol) FROM
    SELECT customer_id, SUM(volume) AS vol
        FROM daily_agg GROUP BY customer_id
        WHERE date >= ’01-01-2013’ AND date < ’01-08-2013’
    UNION
    SELECT customer_id, vol
        FROM qcf(‘SELECT customer_id, COUNT(*) AS vol
    FROM cdr GROUP BY customer_id’)
GROUP BY customer_id
```

FIG. 4 illustrates a computing system for handling a query involving multiple data sources, according to an example. Computing system 400 may include and/or be implemented by one or more computers. For example, the computers may be server computers, workstation computers, desktop computers, laptops, mobile devices, or the like, and may be part of a distributed system. The computers may include one or more controllers and one or more machine-readable storage media, as described with respect to processing system 300, for example.

In addition, users of computing system 400 may interact with computing system 400 through one or more other computers, which may or may not be considered part of computing system 400. As an example, a user may interact with system 400 via a computer application residing on system 400 or on another computer, such as a desktop computer, workstation computer, tablet computer, or the like. The computer application can include a user interface (e.g., touch interface, mouse, keyboard, gesture input device).

Computer system 400 may perform methods 100 and 200, and variations thereof, and components 410-460 may be configured to perform various portions of methods 100 and 200, and variations thereof. Additionally, the functionality implemented by components 410-460 may be part of a larger software platform, system, application, or the like. For example, these components may be part of a data analysis system.

Engines 410 and 440 may have access to databases 450 and 460, respectively. The databases may include one or more computers, and may include one or more controllers and machine-readable storage mediums, as described herein. The engines may be connected to the databases via a network. The network may be any type of communications network, including, but not limited to, wire-based networks (e.g., cable), wireless networks (e.g., cellular, satellite), cellular telecommunications network(s), and IP-based telecommunications network(s) (e.g., Voice over Internet Protocol networks). The network may also include traditional landline or a public switched telephone network (PSTN), or combinations of the foregoing.

Processor 420 may be at least one central processing unit (CPU), at least one semiconductor-based microprocessor, other hardware devices or processing elements suitable to retrieve and execute instructions stored in machine-readable storage medium 430, or combinations thereof. Processor 420 can include single or multiple cores on a chip, multiple cores across multiple chips, multiple cores across multiple devices, or combinations thereof. Processor 420 may fetch, decode, and execute instructions 432-436 among others, to implement various processing. As an alternative or in addition to retrieving and executing instructions, processor 420 may include at least one integrated circuit (IC), other control logic, other electronic circuits, or combinations thereof that include a number of electronic components for performing the functionality of instructions 432-436. Accordingly, processor 420 may be implemented across multiple processing units and instructions 432-436 may be implemented by different processing units in different areas of engine 410.

Machine-readable storage medium 430 may be any electronic, magnetic, optical, or other physical storage device that contains or stores executable instructions. Thus, the machine-readable storage medium may comprise, for example, various Random Access Memory (RAM), Read Only Memory (ROM), flash memory, and combinations thereof. For example, the machine-readable medium may include a Non-Volatile Random Access Memory (NVRAM), an Electrically Erasable Programmable Read-Only Memory (EEPROM), a storage drive, a NAND flash memory, and the like. Further, the machine-readable storage medium 430 can be computer-readable and non-transitory. Machine-readable storage medium 430 may be encoded with a series of executable instructions for managing processing elements.

The instructions 432-436 when executed by processor 420 (e.g., via one processing element or multiple processing elements of the processor) can cause processor 420 to perform processes, for example, methods 100 and 200, and/or variations and portions thereof.

For example, query instructions 432 may cause processor 420 of the OLTP execution engine 410 to issue a query requiring first data from an OLTP database 450 and second data from an OLAP database 460. The query can include a sub-query to obtain the second data. The sub-query can be connected to the query via a query connector function that causes the second data to be delivered to the OLTP execution engine 410 from the OLAP execution engine 440 without any intermediate materialization. Sending instructions 434 may cause processor 420 to send the sub-query to an OLAP execution engine 440 associated with the OLAP database 460. The OLAP execution engine 440 may execute the sub-query to obtain the second data from the OLAP database 460.

Receiving instructions 436 may cause processor 420 to receive streaming query results corresponding to the sub-query from the OLAP execution engine 440. The streaming query results represent the second data, and the OLTP execution engine 410 may treat these streaming query results as a data source for the second data. The OLTP execution engine 410 may continue to process the query by retrieving the first data from the OTLP database 450 and performing at least one operation specified by the query on the first data and the second data.

In the foregoing description, numerous details are set forth to provide an understanding of the subject matter disclosed herein. However, implementations may be practiced without some or all of these details. Other implementations may include modifications and variations from the details discussed above. It is intended that the appended claims cover such modifications and variations.

What is claimed is:

1. A method comprising, by a first execution engine:
issuing a query that uses first data stored in a first database and second data stored in a second database, the first execution engine being associated with the first database and a second execution engine being associated with the second database;
sending a sub-query of the query to the second execution engine for execution over the second database to retrieve the second data;
receiving the second data at the first execution engine in a streaming tuple-by-tuple format from the second execution engine; and
executing a remainder of the query.

2. The method of claim 1, wherein receiving the second data at the first execution engine in a streaming tuple-by-tuple format from the second execution engine comprises receiving the second data at the first execution engine directly from the second execution engine rather than the second data being materialized in a table before being received by the first execution engine.

3. The method of claim 1, wherein the first database is an OLTP database and the second database is an OLAP database.

4. The method of claim 1, wherein executing the remainder of the query comprises:
retrieving, by the first execution engine, the first data from the first database; and
performing, by the first execution engine, at least one operation specified by the query on the first data and the second data.

5. The method of claim 1, wherein the first execution engine treats the streaming second data received from the second execution engine as a data source.

6. A system comprising:
a first database accessible via a first execution engine;
a second database accessible via a second execution engine,
a query executor on the first execution engine to execute a query requiring first data from the first database and second data from the second database, the query comprising a sub-query directed to the second execution engine,
the query executor configured to receive streaming query results of the sub-query from the second execution engine.

7. The system of claim 6, wherein the first database is an OLTP database storing current data and the second database is an OLAP database storing historical data, the first database storing certain recent data not available on the second database.

8. The system of claim 6, wherein the second database is not directly accessible via the first execution engine.

9. The system of claim 6, wherein the query executor is configured to send the sub-query to the second execution engine for execution over the second database.

10. The system of claim 6, wherein the sub-query is connected to the query via a query connector function that causes the second data to be delivered to the query executor from the second execution engine without any intermediate materialization.

11. The system of claim 6, wherein the query executor is further configured to retrieve the first data from the first database and perform at least one operation specified by the query on the first data and the second data.

12. A non-transitory computer-readable storage medium storing instructions for execution by a computer, the instructions when executed causing an OLTP execution engine to:
issue a query requiring first data from an OLTP data source and second data from an OLAP data source, the query comprising a sub-query to obtain the second data;
send the sub-query to an OLAP execution engine associated with the OLAP data source; and
receive streaming query results corresponding to the sub-query from the OLAP execution engine.

13. The computer-readable storage medium of claim 12, the instructions when executed causing the OLTP execution engine to treat the streaming query results corresponding to the sub-query as a data source for the second data.

14. The computer-readable storage medium of claim 12, the instructions when executed causing the OLTP execution engine to:
retrieve the first data from the OLTP data source using the OLTP execution engine; and
perform at least one operation specified by the query on the first data and the second data.

15. The computer-readable storage medium of claim 12, wherein the sub-query is connected to the query via a query connector function that causes the second data to be delivered to the OUT execution engine from the OLAP execution engine without any intermediate materialization.
